(19) United States
(12) Patent Application Publication
(10) Pub. No.: US 2006/0274612 A1
(43) Pub. Date: Dec. 7, 2006

(54) Recording medium, apparatus for reproducing data, method thereof, apparatus for storing data and method thereof

(75) Inventor: Kun Suk Kim, Anyang-si (KR)

Correspondence Address: HARNESS, DICKEY & PIERCE, P.L.C., P.O. BOX 8910, RESTON, VA, 20195, US

(73) Assignee: LG Electronics Inc.

(21) Appl. No.: 11/444,368

(22) Filed: Jun. 1, 2006

Related U.S. Application Data
(60) Provisional application No. 60/686,453, filed on Jun. 2, 2005.

(30) Foreign Application Priority Data
Apr. 19, 2006 (KR) 10-2006-0035280

(51) Int. Cl. G11B 21/08

(52) U.S. Cl. 369/30.04

(57) ABSTRACT

A recording medium, apparatus for reproducing data, method thereof, apparatus for storing data and method thereof are disclosed, in which the recording medium is reproduced using data in a persistent storage data. The present invention includes identifying a provider directory for a content provider of a recording medium in a persistent storage by using provider identification information in configuration file of the recording medium; accessing one or more content directories under the provider directory by an application recorded in the recording medium; reading data in the persistent storage; and reproducing the read data according to an execution of the application.

This application claims the benefit of Korean Patent Application No. 10-2006-0035280, filed on Apr. 19, 2006, which is hereby incorporated by reference as if fully set forth herein.

This application claims the benefit of the U.S. Provisional Application No. 60/686,453, filed on Jun. 2, 2006, in the name of inventor Kun Suk KIM, entitled “PERSISTENT STORAGE PROTECTION METHOD”, which is hereby incorporated by reference as if fully set forth herein.

### BACKGROUND OF THE INVENTION

1. Field of the Invention

The present invention relates to recording medium playback using a persistent storage, and more particularly, to a recording medium, apparatus for reproducing data, method thereof, apparatus for storing data and method thereof.

2. Discussion of the Related Art

Generally, optical discs capable of recording large-scale data as record media are widely used. Recently, a new high-density record medium, e.g., Blu-ray disc (hereinafter abbreviated BD) or HD-DVD (high definition digital versatile disc) has been developed to store video data of high image quality and audio data of high sound quality for long duration.

The development of the high-density recording medium enables networking with an external environment of the recording medium, a combined reproduction function between data stored in the recording medium and data stored outside the recording medium. And, this development enables data having interactivity with user considerably surpassing that of a conventional recording medium.

Recently, many efforts are made to develop an optical recording/reproducing apparatus enabling reproductions of data within the high-density recording medium and data existing outside the recording medium.

However, high-density medium specifications, which regulate connection between an optical recording/reproducing apparatus and a peripheral device and association between a high-density recording medium and a persistent storage storing data associated with the high-density recording medium, has not been completed, which causes difficulty in developing the optical recording/reproducing apparatus.

And, a preferable method for protecting contents of a high-density recording medium and data provided from an outside a recording medium by being associated with the high-density recording medium is unknown so far.

Moreover, a preferable method for protecting a user's optical recording/reproducing apparatus storing data externally downloaded has not been known yet.

Hence, many limitations are put on the development of a full-scale optical recording/reproducing apparatus based on a high-density recording medium.

### SUMMARY OF THE INVENTION

Accordingly, the present invention is directed to a recording medium, apparatus for reproducing data, method thereof, apparatus for storing data and method thereof that substantially obviate one or more problems due to limitations and disadvantages of the related art.

An object of the present invention is to provide a recording medium, apparatus for reproducing data, method thereof, apparatus for storing data and method thereof, by which connections between the recording medium and a persistent storage associated with the recording medium are regulated.

Another object of the present invention is to provide a recording medium, apparatus for reproducing data, method thereof, apparatus for storing data and method thereof, by which contents provided by an authentic content provider and a user's payback system can be protected.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings. To achieve these objects and other advantages and in accordance with the purpose of the invention, as embodied and broadly described herein, a recording medium according to the present invention comprises a configuration file including provider identification and content identification information; and an application being able to access a persistent storage where data associated with the recording medium is stored, wherein the provider identification information is used to identify a provider directory for content provider of the recording medium, and the content identification information is used to identify a content directory for the recording medium under the provider directory in the persistent storage, and wherein the application is able to access one or more content directories under the provider directory.

The recording medium can further comprise a certificate used for authentication of the data in the persistent storage.

The recording medium can further comprise a certificate used for authentication of the application in the persistent storage.

The the provider identification information can identify content provider of the recording medium.

The content identification information can identify content of the recording medium.

In another aspect of the present invention, a method of reproducing data comprises identifying a provider directory for a content provider of a recording medium in a persistent storage by using provider identification information in configuration file of the recording medium; accessing one or more content directories under the provider directory by an application recorded in the recording medium; reading data in the persistent storage; and reproducing the read data according to an execution of the application.

The content directories accessed by the application can include content directory for other recording medium of the content provider, and are identified by content identification information in the application.

The method of reproducing data can further comprise verifying whether the data in the persistent storage is digitally signed by a trusted authority.

The read data can be reproduced in a full mode (FullTrustedMode) in case of being verified as digitally signed by the trusted authority, or in a restricted mode (RestrictedMode) in case of being verified as not digitally signed by the trusted authority.

The method of reproducing data can further comprises verifying whether the application is digitally signed by a trusted authority, wherein the execution of the application is halted in case of being verified as not digitally signed by the trusted authority.

In another aspect of the present invention, an apparatus for reproducing data comprises a persistent storage storing data associated with a recording medium; a reader unit reading the data associated with the recording medium in the persistent storage; and a controller identifying a provider directory for a content provider of the recording medium by using provider identification information in configuration file of the recording medium, the controller accessing one or more content directories under the provider directory by an application in the recording medium, the controller reading and reproducing the data associated with the recording medium according to an execution of the application.

The persistent storage can include a content directory according to content identification information in configuration file of the recording medium under the provider directory.

The content directories accessed by the application can include a content directory of other recording medium of the content provider.

The content directories accessed by the application can be identified by the content identification information in the application.

The apparatus of reproducing data can further comprise an authentication unit verifying whether the data stored in the persistent storage is digitally signed by a trusted authority.

The controller can control the data stored in the persistent storage to be reproduced in a full mode (FullTrustedMode) in case of being verified as digitally signed by the trusted authority, or in a restricted mode (RestrictedMode) in case of being verified as not digitally signed by the trusted authority.

The authentication unit can verify whether the application is digitally signed by a trusted authority.

The controller can halt the execution of the application in case of being verified as not digitally signed by the trusted authority.

In another aspect of the present invention, a method of storing data in a persistent storage comprises creating a provider directory according to provider identification information of a recording medium in a persistent storage; creating a content directory according to content identification information in a configuration file of the recording medium under the provider directory; and storing data associated with the recording medium in the content directory.

The provider directory can be created by a player.

The content directory can be created by an application being able to access the provider directory.

In another aspect of the present invention, an apparatus for storing data in a persistent storage comprises a recording unit storing data associated with a recording medium in a persistent storage; and a controller creating a provider directory according to provider identification information in a configuration file of the recording medium in a persistent storage, the controller creating a content directory according to content identification information of the configuration file under the provider directory, the controller controlling the recording unit to store the data associated with the recording medium in the content directory.

The controller can create the content directory using an application being able to access the provider directory.

The apparatus for storing data in a persistent storage can further comprise an authentication unit verifying whether the data associated with the recording medium is digitally signed by a trusted authority.

The apparatus for storing data in a persistent storage can further comprise an authentication unit verifying whether the application is digitally signed by a trusted authority.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exemplary diagram for explaining a combined use between an optical recording/reproducing apparatus and peripheral devices;

FIG. 2 is a block diagram of an optical recording/reproducing apparatus according to the present invention;

FIG. 3 is an overall system model for content of the present invention;

FIG. 4 is a structural diagram of a directory of a persistent storage according to one embodiment of the present invention;

FIG. 5 is a structural diagram for a conceptional understanding of persistent storage protection according to the present invention;

FIG. 6 is a diagram for conceptional understanding of digital signature creation;

FIG. 7 is a diagram for conceptional understanding of authentication through verification of a digital signature;

FIG. 8 is a diagram of a certificate chain used for authentication according to the present invention; and

FIG. 9 is a flowchart of a method of reproducing data according to a first embodiment of the present invention.

FIG. 10 is a flowchart of a method of reproducing data according to a second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, for convenience of explanation, the present invention takes an optical disc, and more particularly, “HD-DVD” as an example of a record medium. Yet, it is apparent that the technical idea of the present invention is identically applicable to other record media.

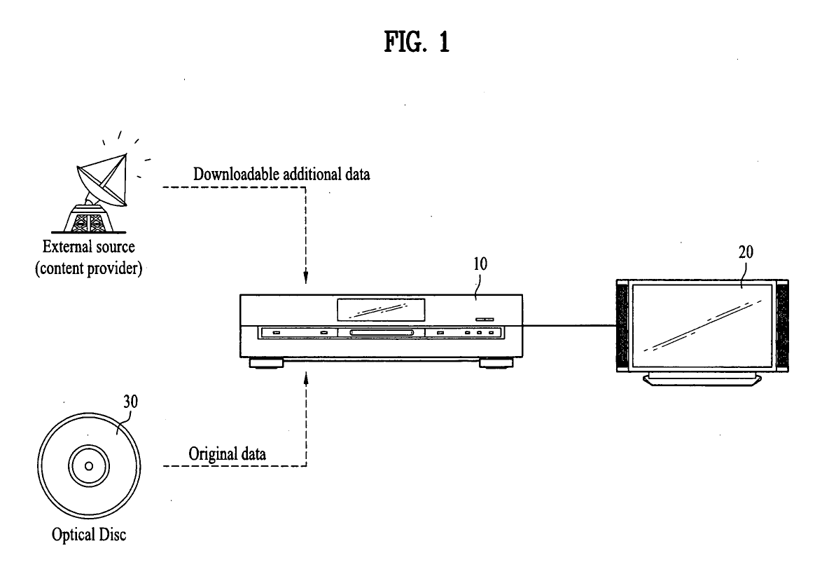

In the present invention, “persistent storage” is a sort of a storage means provided to or connected to an optical recording/reproducing apparatus shown in FIG. 1 and means a storage device storing data with persistency. The persistent storage can be classified into two categories. The first category includes a ‘required persistent storage’ like a flash memory provided within an optical recording/reproducing apparatus. And, the second category includes ‘additional persistent storage’ connectible to or removable from an optical recording/reproducing apparatus like a USB memory, HDD memory or memory card.

The persistent storage is utilized as a means for storing data associated with a recording medium. And, the data stored in the persistent storage is generally downloaded from external source. The data is downloadable from other storage devices in the optical recording/reproducing apparatus. Besides, data can be stored in the persistent storage by being directly read from a recording medium.

For convenience of explanation of the present invention, the data recorded within the record medium is named “original data” and the data associated with the record medium among the data stored within the persistent storage is named “additional data”.

FIG. 1 is an exemplary diagram for explaining a combined use between an optical recording/reproducing apparatus 10 and peripheral devices to facilitate conceptional understanding of the present invention.

Referring to FIG. 1, “optical recording/reproducing apparatus” 10 according to the present invention enables a record or playback of an optical disc according to various specifications. And, the optical recording/reproducing apparatus 10 can be designed to record/reproduce an optical disc (e.g., HD-DVD) of a specific specification. And, it is apparent that the “optical recording/reproducing apparatus” 10 includes “drive” loadable within a computer or the like.

The optical recording/reproducing apparatus 10 according to the present invention is equipped with a function of recording/reproducing an optical disc 30 and a function of receiving an external input signal, performing signal-processing on the received signal, and delivering a corresponding image to a user via another external display 20. In this case, no limitation is put on the external input signal. And, a DMB (digital multimedia broadcast) signal, an Internet signal or the like can be a representative one of the external input signals. In case of Internet as an easily accessible medium, a specific data on Internet can be downloaded via the optical recording/reproducing apparatus 10 to be utilized.

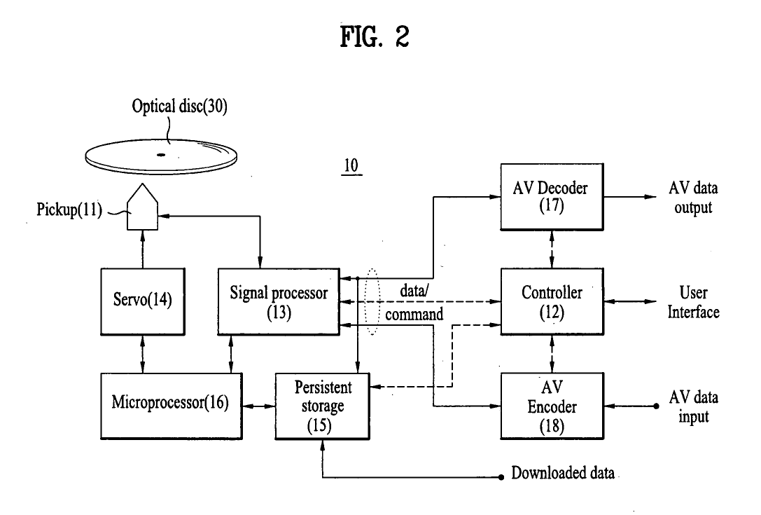

FIG. 2 is a block diagram of an optical recording/reproducing apparatus 10 according to the present invention.

Referring to FIG. 2, an optical recording/reproducing apparatus according to the present invention basically includes a pickup 11 for reproducing original data and management information including reproduction/management file in an optical disc, a servo 14 controlling an action of the pickup 11, a signal processor 13 restoring a reproduction signal received from the pickup 11 to a specific signal value, modulating a signal to be recorded into a signal recordable on the optical disc, and delivering the modulated signal, and a microprocessor 16 controlling the overall operations.

The controller 12 controls additional data, which exists outside an optical disc and is downloaded, to be stored in a persistent storage 15 according to a user's command or the like and controls to manage the persistent storage 15 and an application accessing the persistent storage 15.

In the present invention, an application is a sort of an execution unit and includes a program designed to enable a user or another application to directly perform a specific function. The application officially makes a request for a function to another program or communicates with another program using API (application programming interface). The application may exist within a recording medium or a persistent storage.

In the present invention, the controller 12 can include an authentication unit authenticates an application to be executed and executes the authenticated application. And, the controller 12 is able to control an access of an application distributed by an unauthorized entity to the persistent storage 15 through the authentication. Accordingly, the controller 12 is able to protect the persistent storage and data stored in the persistent storage 15.

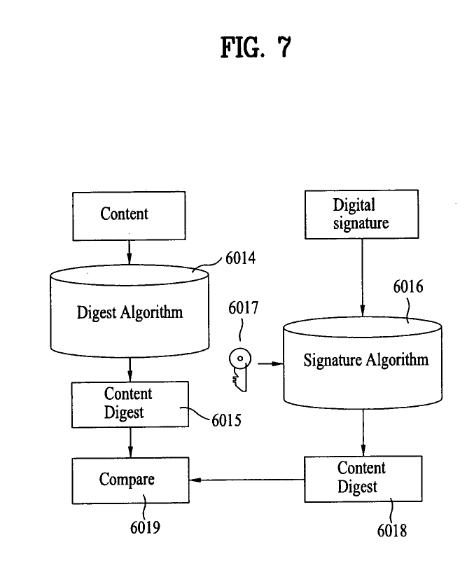

And, the authentication unit authenticates a recording medium loaded in the optical recording/reproducing apparatus 10. If the authentication of the recording medium is successful, the controller 12 controls the recording medium to be played back in a full trust mode (FullTrustMode) that will be explained in a description of FIG. 7.

If the authentication of the recording medium fails, the controller 12 controls the recording medium to be played back in a restricted mode (RestrictedMode) that will be explained in a description of FIG. 7. In the restricted mode, the controller 12 is able to halt an execution of an application that performs such an advanced function as a networking. In this case, it is unable to download data associated with the recording medium from an external server.

For a playback of an untrustworthy recording medium failing in the authentication, the controller 12 is able to restrict an application executing the playback of the recording medium to access the persistent storage 15.

Besides, the controller 12 creates a provider directory and content directory in the persistent storage 15 using configuration file stored in an optical disc 30. The name of the provider directory may be provider identification information which is written in configuration file of the optical disc 30. The name of the content directory may be content identification information which is written in configuration file of the optical disc 30.

An AV decoder 17 finally decodes output data under the control of the controller 12 and then provides the decoded data to a user.

In order to record a signal in the optical disc, an AV encoder 18 converts an input signal to a signal of a specific format, e.g., an MPEG2 transport stream according to a control of the controller 12 and then provides the converted signal to the signal processor 13.

In the present invention, content, which configure a title, mean data provided by disc author or content provider. In the present invention, content is classified into ‘standard content’ and ‘advanced content’. The ‘standard content is extension of content defined in a conventional recording medium specification especially for high-resolution video, high-quality audio and some new functions. The ‘advanced content’ realizes more interactivity in addition to the extension of audio and video realized by the ‘standard content’.

A recording medium according to the present invention is able to include ‘standard content’ and/or ‘advanced content’. Yet, the object of the present invention is to solve a problem caused in reproducing the ‘advanced content’. Hence, the ‘advanced content’ is included in the recording medium according to the present invention.

The ‘advanced content’ includes ‘playlist’, ‘primary video set’, ‘secondary video set’, ‘advanced application’ and ‘advanced subtitle’.

The ‘playlist’ gives playback information between presentation objects such as ‘primary video set’, ‘secondary video set’, ‘advanced application’ and ‘advanced subtitle’. For instance, in order to play back ‘primary video set’, the optical recording/reproducing apparatus accesses a suitable ‘primary enhanced video object’ using information (e.g., URI) described in the ‘playlist’. In particular, the optical recording/reproducing apparatus interprets ‘playlist’ to play back ‘advanced content’.

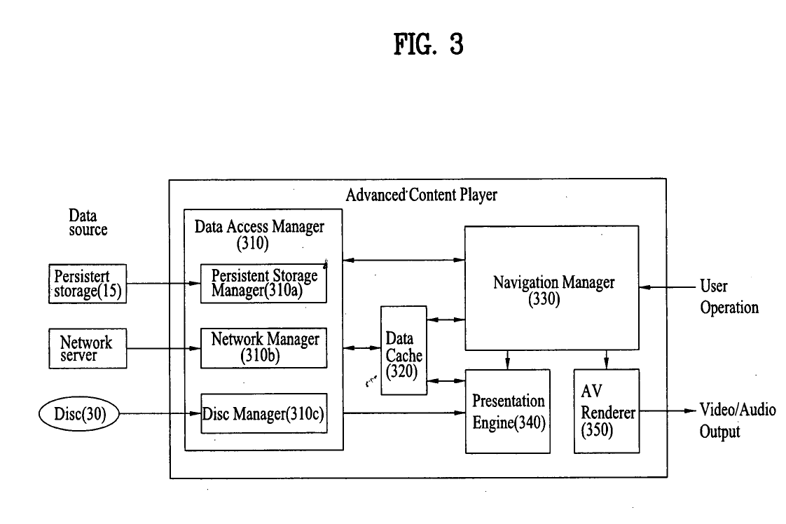

FIG. 3 is an overall system model for contents of the present invention, in which the optical recording/reproducing apparatus of FIG. 2 is shown in aspect of ‘advanced content’.

Referring to FIG. 3, a data source of ‘advanced content’ can be a recording medium, a network server or a persistent storage 15. In particular, in the present invention, one of data sources of the ‘advanced content’ is the persistent storage as a data source.

A data source is an object that is accessed by an application to perform a specific function. Data within the data source becomes resources that configure ‘advanced content’. And, presentation of the ‘advanced content’ is performed by a representation of the resources.

And, data exchanges between the data sources and internal modules of the optical recording/reproducing apparatus are controlled by a data access manager 310.

The data access manager 310 within the optical recording/reproducing apparatus of the present invention includes a persistent storage manager 310a. The persistent storage manager’ 310a controls a data exchange between the persistent storage 15 and the internal modules of the optical recording/reproducing apparatus 10. The persistent storage manager 310a is responsible to provide file access API set for the persistent storage 15. The persistent storage 15 may support file read/write functions.

The data access manager 310 can include a network manager 310b. The network manager 310 controls a data exchange between the network server and the internal modules of the optical recording/reproducing apparatus 10. The network manager 310 is responsible to provide file access API set for the network server. And, the network server usually supports file download and may support file upload.

A navigation manager 330 invokes a file download/upload between the network server and a data cache 320 in accordance with advanced application. The navigation manager 330 also controls user interface devices including a remote controller, a front panel of the optical recording/reproducing apparatus, a mouse, a game pad and the like. And, events received from the user interface devices are handled by the navigation manager 330.

The network manager 320b is able to provide a protocol level access function to a presentation engine 340. The presentation engine 340 decodes presentation data and outputs the decoded data to an AV renderer 350 in response to control commands from the navigation manager 330.

The AV renderer 350 combines graphic planes coming from the presentation engine 340 and the navigation manager 330, and outputs the combined video signal. And, the AV renderer 350 mixes PCM (pulse code modulation) streams provided from the presentation engine 340 and outputs the mixed audio signal.

Moreover, the data access manager 310 includes a disc manager 310c. The disc manager 310c controls data reading from the recording medium to internal modules of the optical recording/reproducing apparatus 10 and provides file access API set for the recording medium.

Meanwhile, the advanced application is defined as a set of resources selected from the family of content formats. Each advanced application consists of elements drawn from a set of content files, a set of timing content files, a set of behavior (script) content files, a set of style description files, a set of image resources and a set of audio resources.

The elements are organized into an advanced application by a single manifest file. The resources of an advanced application form a directed graph, rooted by the resource referenced in the manifest file of the advanced application.

The interpretation of an advanced application is handled by the presentation engine 340 within the optical recording/reproducing apparatus 10. The advanced application is conceived in terms of controlled placement of graphics on the graphics (or sub-picture) plane synchronized with the playing media on the main-video and sub-video planes.

The advanced application enables interaction between a user and video playback through the remote controller and other optional devices.

In the present invention, the advanced application identifies persistent storages from one another to access the corresponding persistent storage. The advanced application is able to read/write/create/delete a file and directory on the persistent storage using file I/O APIs.

And, the advanced application manages a network function within the optical recording/reproducing apparatus such as an operation of receiving additional data downloaded from an outside of a recording medium.

Original data and additional data are explained in detail as follows. For instance, if a multiplexed AV stream for a specific title is recorded as an original data recorded within an optical disc and if an audio stream (e.g., English) different from the audio stream (e.g., Korean) of the original data is provided as an additional data on Internet, a request for downloading the audio stream (e.g., English) as the additional data on Internet to reproduce together with the AV stream of the original data or a request for downloading the audio stream (e.g., English) as the additional data on Internet to reproduce only will exist according to a user. To enable the requests, association between the original data and the additional data needs to be regulated and a systematic method of managing/reproducing the data according to a user's request is needed.

For the convenience of explanation in the above description, a signal recorded within a disc is named original data and a signal existing outside the disc is named additional data, which is identified according to a method of acquiring each data but does not put limitation on restricting the original or additional data to specific data. Hence, data having any kind of attribute, which exists outside the optical disc and is associated with the original data, can become the additional data.

The object of the present invention is to reproduce additional data within a persistent storage by associating the additional data with original data. So, a file structure associated between a recording medium storing original data and a persistent storage storing additional data is needed. Hence, the present invention provides a file structure of a persistent storage enabling additional data to be reproduced together with specific data of a recording medium.

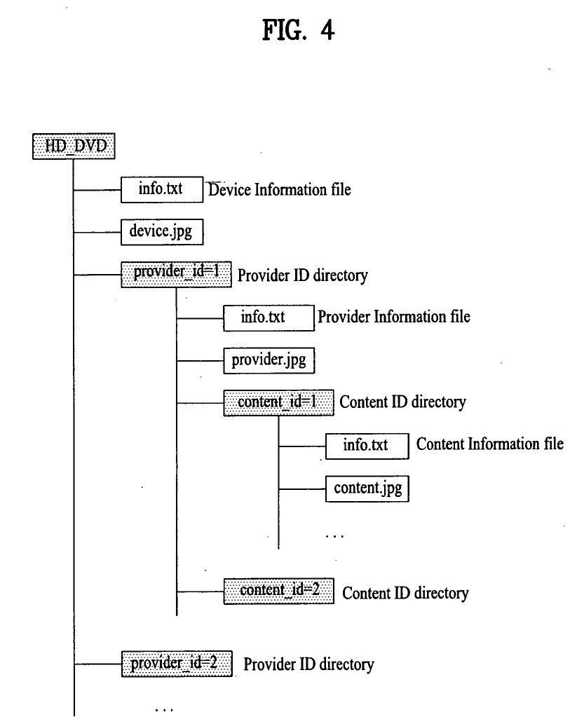

FIG. 4 is a structural diagram of a directory of a persistent storage according to one embodiment of the present invention.

Referring to FIG. 4, a persistent storage of the present invention includes independent areas for each content provider. The persistent storage includes ‘Provider ID directory’ (hereinafter called provider directory) for each content provider. Each provider directory exists under ‘HD-DVD’ directory. And, the HD-DVD directory exists below a root directory. Preferably, the provider directory has a name of GUID (globally unique ID) or UUID (universally unique ID) format. Each recording medium according to present invention has provider identification information (hereinafter, Provider ID) to identify the content provider. The provider ID is stored in a configuration file on a recording medium. The Provider ID is presented to an optical recording/reproducing apparatus 10 at startup sequence of advanced content playback.

When advanced applications attempt to access a persistent storage, if HD-DVD directory does not exist in the persistent storage, an optical recording/reproducing apparatus 10 creates the HD-DVD directory. If a provider directory does not exist, an optical recording/reproducing apparatus 10 creates the provider directory. And, Provider ID stored in a configuration file of a recording medium loaded in the optical recording/reproducing apparatus is used as a name of the provider directory.

Besides, the configuration file is used in identification of an area assigned to a disc in the persistent storage. The configuration file of the present invention includes a provider ID of a content provider having provided a recording medium content and a content ID of the recording medium content. And, a disc ID of the recording medium can be included in the configuration file. The disc ID can be used for recording medium authentication via network.

Advanced applications are able to access the area of own content provider, and not able to access the areas of other content providers. In other words, advanced applications able to access provider directory of own content provider, and not able to access provider directories of other content providers. In instance, in case that an advanced application is provided by a content provider whose provider ID is ‘1’, the advanced application is able to access a directory of ‘Provider_id=1’ but unable to access a directory of ‘Provider_id=2’. Yet, the persistent storage of the present invention can have a common directory that can be accessed by the advanced application without limitation of a content provider.

The persistent storage 15 of the present invention includes Content ID directory (hereinafter called content directory). The content directory stores data associated with each recording medium. A content ID of the content ID directory is used to identify the recording medium content.

An advanced application may know at least one or more content IDs for each recording medium content of own content provider. For each recording medium, an advanced application is able to access at least one or more areas storing data in the persistent storage. Theses areas are identified by content IDs, respectively.

On the other hand, each recording medium of the present invention has a single content ID, which identifies a recording medium content. The content ID is written in a configuration file of the recording medium. In case that an optical recording/reproducing apparatus tries to use a playlist file stored in a persistent storage, the optical recording/reproducing apparatus is able to search the playlist file using the content ID in the configuration file. The playlist file is stored under content directory. At startup sequence of advanced content, if optical recording/reproducing apparatus 10 tries to use the playlist file stored in the persistent storage 15, the optical recording/reproducing apparatus 10 searches the playlist file using URI. The URI includes a provider ID and content ID which is written in configuration file of the recording medium.

Besides, the content directory is created but by an optical recording/reproducing apparatus but by an advanced application. The advanced application is able to access at least one content directory existing under own provider ID directory. And, the content directory is used to divide the unit which is displayed to a user.

The persistent storage of the present invention has a device ID given to each persistent storage by an optical recording/reproducing apparatus and can be identified by the device ID.

A device information file, a provider information file and a content information file can be included in the persistent storage of the present invention.

The device information file exists below the HD-DVD directory and includes a description of the persistent storage.

The provider information file exists under the provider directory. According to the number of provider directories, a plurality of provider information files can exist in a single persistent storage. Preferably, an advanced application is able to access its provider directory but unable to access other provider directories.

And, the content information file exists under the content directory. A plurality of content information files may exist in a single persistent storage.

The optical recording/reproducing apparatus of the present invention is able to delete files/directories by accessing a persistent storage and to obtain specific values from the above-explained information files. And, the optical recording/reproducing apparatus of the present invention is able to copy any files/directories in a persistent storage to other persistent storage.

In the persistent storage structure of the present invention, each persistent storage area can be identified as a script by a logical address (e.g., URI (uniform resource identifier). The logical address indicates a file stored in a persistent storage. A persistent storage type (‘required’ or ‘additional), a provider ID, a content ID, a file name and the like can become elements that configure the logical address. Content ID in the logical address is specified by advanced application, and not limited by the content ID written in the configuration file of recording medium to be played back. Using a file I/O API with the logical address, an advanced application is able to access one or more content directories under its provider directory or common directory area. The advanced application are able to access not only a content directory for recording medium to be played but also content directories for other recording medium of own content provider. Therefore, recording media of one content provider can share data under own provider directory. According to an execution of the advanced application, it is able to reproduce recording medium associated data stored in a persistent storage.

Meanwhile, the optical recording/reproducing apparatus of the present invention provides a method of managing directories stored in a persistent storage to a user. This is performed via a persistent storage management menu. In the persistent storage management menu, an access unit of an application is not a file unit but a provider or content directory unit. In the persistent storage management menu, the optical recording/reproducing apparatus provides information for an available persistent storage such as a device name, a slot name, a used size, an available size and the like to a user.

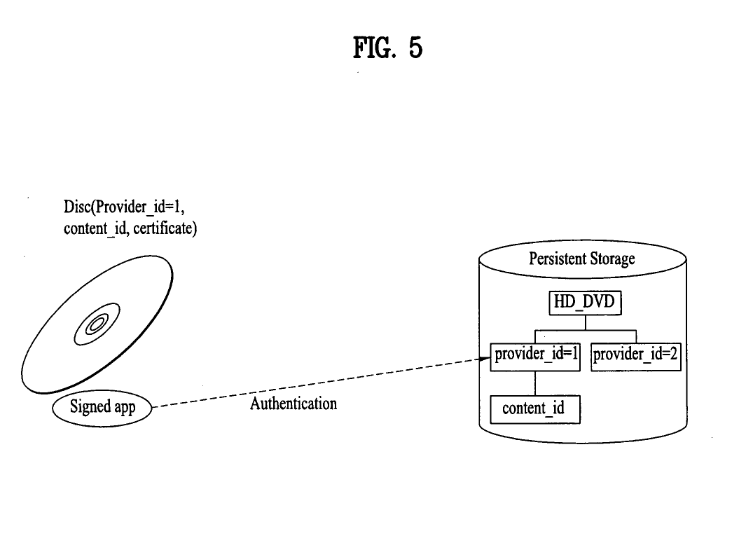

FIG. 5 is a structural diagram for a conceptional understanding of persistent storage protection according to the present invention.

Referring to FIG. 5, necessity for contents protection rises as high-size/high-resolution video/high-quality audio data are provided. So, a protection scheme for a persistent storage storing these data is required. If areas of a persistent storage are divided according to content providers and recording medium content, it is able to limit an advanced application not to access other provider directories. Hence, it is able to protect the persistent storage and the data stored in the persistent storage.

The present invention intends to further provide a method of protecting content and a persistent storage more safely. In particular, the present invention provides a method of protecting content of a content provider and a persistent storage by authenticating data prior to a reproduction of the data stored in the persistent storage. In this case, the data stored in the persistent storage is reproduced by being added to, replaced by or associated with content data of a loaded recording medium.

In a recording medium according to the present invention, at least one certificate is recorded as well as a configuration file storing one provider ID and one content ID. The certificate can be used in authenticating data stored in a specific area of a persistent storage identified by the provider ID and the content ID.

For the authentication of the present invention, a trusted authority digitally signs data to guarantee authenticity of the data and then provides the signed data to a user. The signed data includes a digital signature of the authority. The digital signature is used in verifying whether data is provided by an authentic entity. And, the digital signature is used in checking whether data is modified or forged in the process of providing the data. An entity having a secret key can make a digital signature and should prove that the digital signature is made by the entity himself. And, it is unable to modify the signed data.

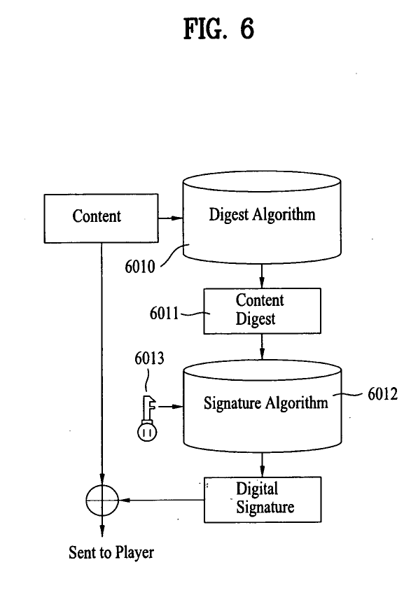

FIG. 6 is a diagram for conceptional understanding of digital signature creation.

Referring to FIG. 6, a content provider applies content to be provided to a digest algorithm 6010. Content digest 6011 corresponding to the content is computed through the digest algorithm.

A digital signature is created by applying the content digest 6011 to a signature algorithm 6012. A private key 6013 of the content provider who provides the content is used for the signature algorithm 6012. And, the created digital signature is provided to an optical recording/reproducing apparatus 10 together with the corresponding content.

Besides, the private key is a key, which is not opened to the public, of an asymmetric key pair, which is used for a public key cryptosystem, of one entity. In some cases, the private key may means a key used in a symmetric key cryptosystem. A key corresponding to the private key is called a public key. And, the public key means a key, which is opened to the public, of an asymmetric key pair, which is used for a public key cryptosystem, of one entity. Moreover, the public key is used in deciding authenticity of a signature in a signature system to be called a verification key as well.

FIG. 7 is a diagram for conceptional understanding of authentication through verification of a digital signature.

Referring to FIG. 7, an optical recording/reproducing apparatus 10 of the present invention is able to restore a digital signature to a digest 6018 through a signature algorithm 6016 using a public key 6017 for a received digital signature. The public key 6017 is a key corresponding to a private key 6013 used for creation of the digital signature. In the digital signature, due to the encryption algorithm characteristics, information encrypted with the private key 6013 should be restored using the public key 6017 corresponding to the private key 6013. Namely, in case that the public key 6017 corresponding to the private key 6013 used for the creation of the digital signature does not exist, the digital signature cannot be restored to the digest 6018. In this case, it cannot be authenticated that a provided application is provided by an authorized content provider. And, the public key 6017 is included within a certificate to be provided to the optical recording/reproducing apparatus 10.

The optical recording/reproducing apparatus 10 computes a digest 6015 by applying a content to be authenticated to a digest algorithm 6014. The digest algorithm 6014 is the digest algorithm used for the creation of the digital signature. The computed digest 6015 is compared to the digest 6018 created from restoring the digital signature. If the compared digests are not identical to each other, a verification of the digital signature fails.

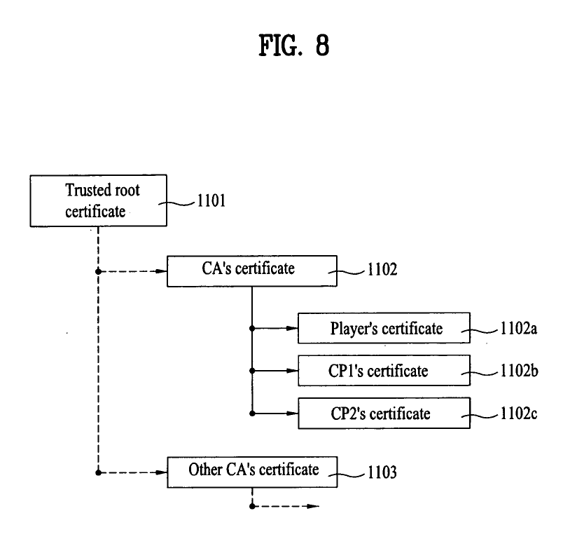

FIG. 8 is a diagram of a certificate chain used for authentication according to the present invention.

An entity having made a signature on content can issue a certificate that certifies authenticity of the entity. And, the entity can be certified by a certificate authority (CA). In this case, the certificate authority issues a certificate including a digital signature of the certificate authority. And, the certificate authority can be certified by another certificate authority in a same manner. Hence, a certification of a specific entity configures a sort of chain that is called a certificate chain.

Referring to FIG. 8, a trusted root certificate authority can certify certificate authorities (1102, 1103). The certificate authority to be certified can be an AACS (advanced access content system) or a CPS (content protection system). In some cases, the AACS or CPS can become a root certificate authority by itself.

The AACS, CPS or other certificate authority can certify lower structures such as an optical recording/reproducing apparatus, a content provider and the like independently (1102a, 1102b, 1102c). Through this step-by-step certification, a certificate chain is configured.

In the certificate chain, a higher certificate authority, which can certify the trusted certificate root authority (CA) does not exist. In this case, the trusted certificate authority certifies itself (1101), which corresponds to a root certification (1101).

Each of the certificate authorities provides a certificate including a digital structure of each of the certificate authorities for a result of certification of itself or its lower structures. A certificate provided by a lowest certificate authority of the certificate chain can be called a leaf certificate, and a certificate provided by a highest certificate authority of the certificate chain can be called a root certificate. As mentioned in the foregoing description of FIG. 7, the certificates can secure the integrity of the public key that restores the digital signature in the verification process of the digital signature.

In some cases, each of the certificate authorities can make a certificate revocation list (CRL). In this case, a content provider and user receives a downloaded the certificate revocation list, and then checks whether a certificate to be used for authentication is revoked before performing the authentication via the certificate. If the certificate to be authenticated is revoked, the authentication is not achieved. If the certificate is not revoked, the authentication is achieved on condition that other authentication requirements are met.

Besides, a trusted root certificate provided by a trusted certificate authority is stored in a specific area of a record medium in a file format or the like to be provided to an optical recording/reproducing apparatus 10.

The verification of the digital signature of the present invention should be made to each chain of the certificate chain. And, the verification of the certificate chain is executed up to a root certificate. If the verifications of intermediate certificates to the root certificate are successfully completed, the certification of the data to be authenticated can be established. Otherwise, if the verification of a certificate within a certificate chain fails in the course of reaching the root certificate, the verification of the digital signature fails. In this case, the data to be authenticated is not the data by an authentic entity. Hence, the authentication is not established.

Certificates of the certificate chain are recorded in a recording medium to be provided to a user or can be downloaded from an outside of the recording medium to a user. And, the certificate may include a version, a serial number, a signature algorithm, an issuer, an expiry date, a subject to be authenticated, a public key, etc.

Advanced content provides a rich and powerful platform for building interactive applications, including persistent storage and networking capabilities. To ensure that the platform is not abused by malicious entities, an optical recording/reproducing apparatus of the present invention can restrict access to some advanced functionality when reproducing distrusted content. The type of abuse concerned about can be piracy-related abuse by malicious entities, and attacks against the optical recording/reproducing apparatus or a user. A persistent storage can be worn out by such abuse and user. Therefore an optical recording/reproducing apparatus according to present invention can operate in a reduced-functionality mode called a restricted mode (RestrictedMode). In the restricted mode, advanced applications of the present invention are controlled to access a restricted set of functionality only. What kind of a function is restricted depends on implementation of an optical recording/reproducing apparatus.

For instance, a recording medium according to the present invention enables a replaceable playlist to be downloaded to a persistent storage. And, an optical recording/reproducing apparatus can load the playlist not from the recording medium but from the persistent storage. In this case, the optical recording/reproducing apparatus verifies the playlist in a manner of verifying whether the playlist is signed by an authentic entity. If the authentication fails since the playlist is not signed or the signing entity is not authentic, the optical recording/reproducing apparatus stops loading the playlist to protect a recording medium content.

In case of detecting an unallowable operation in a restricted mode, an optical recording/reproducing apparatus of the present invention is able to halt a currently executed advanced application. In this case, the optical recording/reproducing apparatus can inform a user that data that is being reproduced is not valid. In some cases, the optical recording/reproducing apparatus is able to halt a whole playback of the corresponding recording medium.

If the authentication of the data is established, i.e., if it is proved that the data is signed by the authentic entity, the optical recording/reproducing apparatus of the present invention can operate in a full mode (FullTrustMode). In the full mode, all kinds of function provided by the optical recording/reproducing apparatus can be performed.

Preferably, the data authentication is executed before a reproduction of the data starts. This is because a start mode for the optical recording/reproducing apparatus should be determined at a playback startup time of the recording medium. For the recording medium, the optical recording/reproducing apparatus of the present invention is unable to simultaneously execute applications in the full and restricted modes. Once a mode is determined at the playback startup, all applications are executed in the same mode while the recording medium is played back.

Preferably, the loaded recording medium is authenticated at the playback startup as well.

The controller 12 of the optical recording/reproducing apparatus 10 can control the authentication unit to verify that the data is provided by an authentic content provider and is not damaged prior to a reproduction start of data within the loaded recording medium.

In case that the authentication of the recording medium is not successful, the controller enables the data to be reproduced in the restricted mode. In this case, such a function as a networking with an external server, an access to a persistent storage and the like can be restricted.

If the optical recording/reproducing apparatus is in the full mode or if an application is allowed to be executed in the restricted mode, the application is able to access the persistent storage. In this case, if the application itself is distributed by a hostile entity or damaged, the persistent storage and the content can be abused.

Hence, the present invention provides a method of protecting a persistent storage and content through authentication of an application accessing the persistent. A certificate is used for the authentication of the application. And, the certificate can be provided to a user through a recording medium or network. The creation and verification of a digital signature for an application have been explained in the descriptions of FIGS. 6 to 8.

An optical recording/reproducing apparatus of the present invention authenticates an application accessing a persistent storage. The authentication process for the application is for the optical recording/reproducing apparatus to verify that the application was digitally signed by a trusted entity. If the application is verified as being signed by such a trusted entity, the optical recording/reproducing apparatus can treat it as trusted application and continue an execution of the application. The application can be permitted to access the corresponding provider directory. Yet, if the application cannot be verified as signed, the optical recording/reproducing apparatus can treat the content as distrusted and halt an execution of the application.

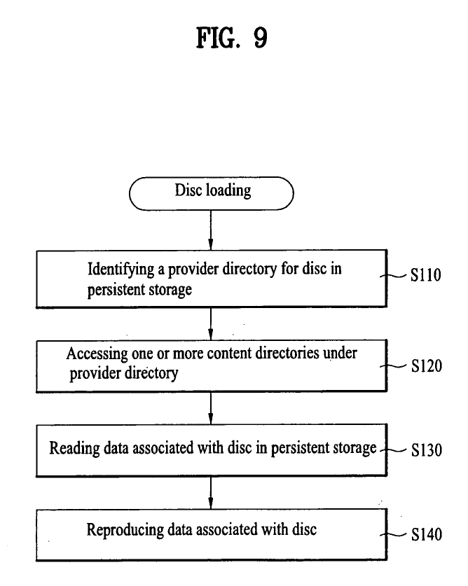

FIG. 9 is a flowchart of a method of reproducing data according to a first embodiment of the present invention.

Referring to FIG. 9, a recording medium according to the present invention enables data associated with the recording medium to be downloaded from a network and to be stored in a persistent storage.

If the recording medium (disc) is loaded, a provider ID is provided to an optical recording/reproducing apparatus at a playback startup sequence of the recording medium playback.

If there is no provider directory corresponding to the provider ID in the persistent storage, the optical recording/reproducing apparatus creates the provider directory. If there is no content directory corresponding to a content ID in a configuration file stored in the disc, an advanced application creates the content directory.

And, the downloaded data is stored in an area corresponding to the provider ID and the content ID in the configuration file.

The optical recording/reproducing apparatus of the present invention identifies the provider directory where data to be reproduced exists (S110). And, the optical recording/reproducing apparatus accesses one or more content directories under provider directory by using URIs specified by advanced applications (S120).

The URIs indicates where data to be reproduced exists. The URIs can include content ID in a configuration file of the loaded disc and content IDs of other disc. A content provider according to the present invention can configure the advanced applications including data associated other discs, and record URIs describing where the data exist. Therefore, the advanced applications are able to access not only content directory of the loaded disc but also other content directories under own provider directory of own content directory. So, the content provider can share data among own discs. Content directories to be accessed by the applications are identified by content IDs (including content ID in the configuration file of the loaded disc).

The advanced applications according to the presentation are not able to access provider directories of other content providers. Hence, the present invention can protect contents provided by a content provider from being used by other entities.

The optical recording/reproducing apparatus reads data under the accessed one or more content directories in the persistent storage (S130), and reproduces the data (S140). The content directories include a content directory which is allocated to the loaded disc and content directory which is allocated to other disc.

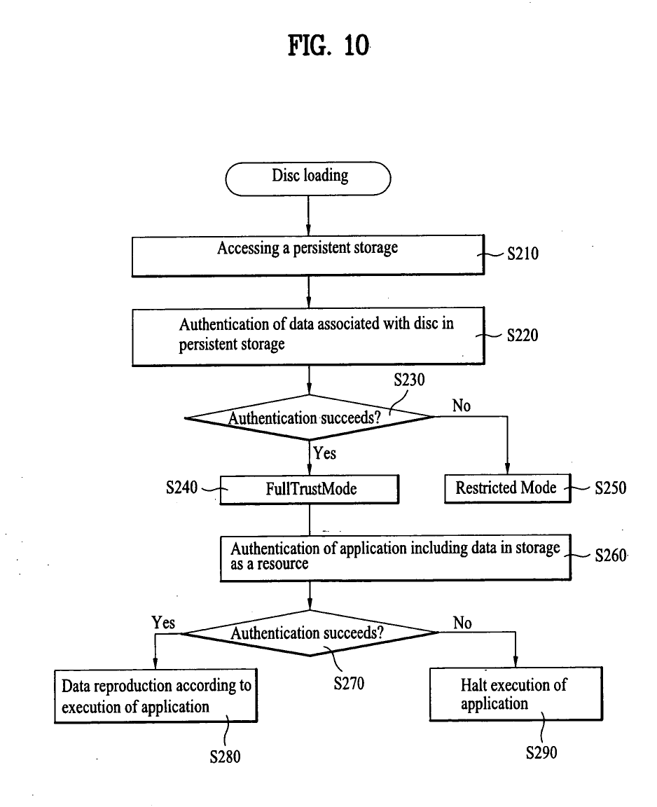

FIG. 10 is a flowchart of a method of reproducing data according to a second embodiment of the present invention.

In case that a recording medium (disc) is loaded, a optical recording/reproducing apparatus can perform networking with outside source and download data associated with the loaded disc from the outside source to a persistent storage. At playback startup sequence of advanced content in the disc, a provider ID written a configuration file of the disc is provided to the optical recording/reproducing apparatus. The downloaded data is stored within a specified area in the persistent storage. The specified area is identified by a provider ID and a content ID written in the configuration file.

The optical recording/reproducing apparatus accesses the persistent storage (S210). Areas to be accessed in the persistent storage are identified by a provider ID and content IDs in URIs.

To protect content of the loaded disc and the persistent storage, the data stored in the persistent storage is authenticated prior to a reproduction (S220). The authentication can be performed in a manner of checking whether a trusted entity digitally signs on the data in the persistent storage. Namely, optical recording/reproducing apparatus verifies that the data in the persistent storage has been digitally signed by an entity approved by a trusted authority.

A certificate for certifying that the entity is a trusted entity is used for the authentication. Moreover, the certificate may include a certificate chain. In this case, all certificates of the certificate chain should be verified until each chain of the certificate chain reaches a certificate of provider's root certificate authority (hereinafter, root certificate). If it is verified that the process up to the root certificate is trustworthy, the authentication of the data is successful. If any one chain fails in the verification, the data authentication fails.

According to a success or failure of the data authentication (S230), the optical recording/reproducing apparatus operates in a FullTrustMode (S240) or RestrictedMode (S250). If the data authentication succeeds, the optical recording/reproducing apparatus operates in the FullTrustMode (S240). If the data authentication fails, the optical recording/reproducing apparatus operates in the RestrictedMode (S250).

If the optical recording/reproducing apparatus operates in the FullTrustMode (S240), all functions, which can be provided the optical recording/reproducing apparatus, can be executed. In particular, all applications of the loaded disc or the optical recording/reproducing apparatus can basically access reproduction resources freely. So, the application including resources in a persistent storage among the applications of the loaded disc is able to access the persistent storage.

The optical recording/reproducing apparatus of the present invention authenticates the application accessing the persistent storage for the more powerful protections of the persistent storage and content (S260). The application of the present invention can be provided to a user after a digitally signed by a content provider. And, the optical recording/reproducing apparatus authenticates the application in a manner of verifying whether the application is signed by an authentic content provider.

According to a success or failure of the authentication (S270), the optical recording/reproducing apparatus decides whether to execute the application.

In particular, if the application is signed by a trusted certificate authority and if all certificate chain up to a root certificate is verified, the optical recording/reproducing apparatus reproduces the data within the persistent storage together with the recording medium according to an execution of the application.

On the other hand, if the application is not signed or if it is decided that the signature is not trusted, the optical recording/reproducing apparatus halt the execution of the application (S280). In this case, the optical recording/reproducing apparatus can provide information informing a user that the application is not valid. In some cases, the optical recording/reproducing apparatus is able to halt the whole playback of the recording medium.

If the optical recording/reproducing apparatus is in the RestrictedMode and if an unauthorized action is detected in the RestrictedMode, the optical recording/reproducing apparatus halts the application that is currently executed. For more powerful protections of the persistent storage and content, the present invention enables the application to keep being executed after authentication of the application which is able to access the persistent storage in the RestrictedMode. The authentication is identical to the aforesaid authentication process of the application and the processing according to a success or failure of the authentication can be identical to that in the FullTrustMode.

Accordingly, the present invention provides the following effects and/or advantages.

First of all, it is able to implement various contents by reproducing data stored in a record medium using a persistent storage.

Secondarily, the present invention can protect contents provided by a content provider and a user's optical recording/reproducing apparatus. Hence, the content provider can provide safe contents and the user can play back the contents with security. Therefore, the present invention can provide more convenient functions.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A recording medium comprising:
a configuration file including provider identification and content identification information; and
an application being able to access a persistent storage where data associated with the recording medium is stored,
wherein the provider identification information is used to identify a provider directory for content provider of the recording medium, and the content identification information is used to identify a content directory for the recording medium under the provider directory in the persistent storage, and
wherein the application is able to access one or more content directories under the provider directory.

2. The recording medium of claim 1 further comprising:
a certificate used for authentication of the data in the persistent storage.

3. The recording medium of claim 1 further comprising:
a certificate used for authentication of the application in the persistent storage.

4. The recording medium of claim 1, wherein the provider identification information identifies content provider of the recording medium.

5. The recording medium of claim 1, wherein the content identification information identifies content of the recording medium.

6. A method of reproducing data, comprising the steps of:
identifying a provider directory for a content provider of a recording medium in a persistent storage by using provider identification information in configuration file of the recording medium;
accessing one or more content directories under the provider directory by an application recorded in the recording medium;
reading data in the persistent storage; and
reproducing the read data according to an execution of the application.

7. The method of claim 6, wherein the content directories accessed by the application include content directory for other recording medium of the content provider, and are identified by content identification information in the application.

8. The method of claim 7, further comprising a step of:
verifying whether the data in the persistent storage is digitally signed by a trusted authority.

9. The method of claim 8, wherein the read data is reproduced in a full mode (FullTrustedMode) in case of being verified as digitally signed by the trusted authority, or in a restricted mode (RestrictedMode) in case of being verified as not digitally signed by the trusted authority.

10. The method of claim 7, further comprising a step of:
verifying whether the application is digitally signed by a trusted authority,
wherein the execution of the application is halted in case of being verified as not digitally signed by the trusted authority.

11. An apparatus for reproducing data, comprising:
a persistent storage storing data associated with a recording medium;
a reader unit reading the data associated with the recording medium in the persistent storage; and
a controller identifying a provider directory for a content provider of the recording medium by using provider identification information in configuration file of the recording medium, the controller accessing one or more content directories under the provider directory by an application in the recording medium, the controller reading and reproducing the data associated with the recording medium according to an execution of the application.

12. The apparatus of claim 11, wherein the persistent storage includes a content directory according to content identification information in configuration file of the recording medium under the provider directory.

13. The apparatus of claim 11, wherein the content directories accessed by the application include a content directory of other recording medium of the content provider.

14. The apparatus of claim 11, wherein the content directories accessed by the application is identified by the content identification information in the application.

15. The apparatus of claim 11, further comprising:
an authentication unit verifying whether the data stored in the persistent storage is digitally signed by a trusted authority.

16. The apparatus of claim 15, wherein the controller controls the data stored in the persistent storage to be reproduced in a full mode (FullTrustedMode) in case of being verified as digitally signed by the trusted authority, or in a restricted mode (RestrictedMode) in case of being verified as not digitally signed by the trusted authority.

17. The apparatus of claim 11, wherein the authentication unit verifies whether the application is digitally signed by a trusted authority.

18. The apparatus of claim 17, wherein the controller halts the execution of the application in case of being verified as not digitally signed by the trusted authority.

19. A method of storing data in a persistent storage, comprising the steps of:
creating a provider directory according to provider identification information of a recording medium in a persistent storage;
creating a content directory according to content identification information in a configuration file of the recording medium under the provider directory; and
storing data associated with the recording medium in the content directory.

20. The method of claim 19, wherein the provider directory is created by a player.

21. The method of claim 19, wherein the content directory is created by an application being able to access the provider directory.

22. An apparatus for storing data in a persistent storage, comprising:
a recording unit storing data associated with a recording medium in a persistent storage; and
a controller creating a provider directory according to provider identification information in a configuration file of the recording medium in a persistent storage, the controller creating a content directory according to content identification information of the configuration file under the provider directory, the controller controlling the recording unit to store the data associated with the recording medium in the content directory.

23. The apparatus of claim 22, wherein the controller creates the content directory using an application being able to access the provider directory.

24. The apparatus of claim 22, further comprising:
an authentication unit verifying whether the data associated with the recording medium is digitally signed by a trusted authority.

25. The apparatus of claim 22, further comprising:
an authentication unit verifying whether the application is digitally signed by a trusted authority.
